(19) United States
(12) Patent Application Publication
(10) Pub. No.: US 2024/0385020 A1
(43) Pub. Date: Nov. 21, 2024

(54) METHOD AND FLOWMETER FOR DETECTING A FLOW TIME OF A FLUID

(71) Applicant: Fraunhofer-Gesellschaft zur Förderung der angewandten Forschunge e.V., München (DE)

(72) Inventors: Leonhard SCHMIEDER, Freiburg im Breisgau (DE); Peter KOSS, Freiburg (DE); Frank KÜHNEMANN, Freiburg im Breisgau (DE)

(73) Assignee: Fraunhofer-Gesellschaft zur Förderung der angewandten Forschunge e.V., München (DE)

(21) Appl. No.: 18/696,093

(22) PCT Filed: Sep. 26, 2022
(86) PCT No.: PCT/EP2022/076626

§ 371 Date: Mar. 27, 2024

(30) Foreign Application Priority Data
Sep. 30, 2021 (EP) 21200351.1

(51) Int. Cl. G01F 1/708

(52) U.S. Cl. CPC G01F 1/708

(57) ABSTRACT

A method for detecting a flow time which a fluid requires to flow through a measurement path from a manipulation location to a detection location spaced from the manipulation location in a flow direction of the fluid, the method including the steps A) providing a flow of the fluid, B) changing a nuclear magnetic or electron magnetic polarization of the fluid at the manipulation location at a first point in time, C) measuring a magnetic flux density of a magnetic field emanating from the fluid due to the nuclear magnetic or electron magnetic polarization as a function of time at the detection location, and D) determining the flow time as a difference between the first point in time and a second point in time. At the second point in time the changing of the nuclear magnetic or electron magnetic polarization at the manipulation location from step B) causes a change in the flux density of the magnetic field emanating from the fluid at the detection location, and a flow meter for carrying out such a method.

The present invention relates to a method and a flow meter for detecting a flow time required by a fluid to flow through a measuring path from a manipulation location to a detection location spaced apart from the manipulation location in a flow direction of the fluid.

In order to determine the volume flow of a fluid through a fluid guide, in particular a pipe, it is usually sufficient to measure the flow time of the fluid which the fluid requires to flow through a measuring path between two spaced locations of the fluid guide. Various measurement methods are known from the prior art for measuring volumetric flow. These include methods that utilise the nuclear spin or electron spin properties of the fluid using nuclear spin or electron spin resonance methods. The latter are generally based on relaxation processes and require a complex apparatus set-up, as is the case with nuclear magnetic resonance measurement methods.

In contrast, the object of the present invention is to provide a flow measurement based on the nuclear spin or electron spin properties of a fluid with reduced apparatus complexity.

The aforementioned object is solved by a method according to the appended independent claim 1. For detecting the flow time required for a fluid to flow through a measuring path from a manipulation location to a detection location spaced from the manipulation location in a flow direction of the fluid, wherein the method comprises the steps of:
A) providing a flow of the fluid,
B at a first point in time, changing a nuclear magnetic or electron magnetic polarisation of the fluid at the manipulation location,
C) measuring a magnetic flux density of a magnetic field emanating from the fluid due to the nuclear magnetic or electron magnetic polarisation as a function of time at the detection location, and
D) determining the flow time as the difference between the first point in time and a second point in time, wherein at the second point in time the change in the nuclear magnetic or electron magnetic polarisation at the manipulation location from step B) causes a change in the flux density of the magnetic field emanating from the fluid at the detection location.

The basic idea of the present invention is to realise a time-of-flight measurement for a fluid, wherein a change in a state of the fluid at a first location, namely the manipulation location, at a first point in time can be detected at a second location, namely the detection location, at a second point in time. The second point in time essentially depends exclusively on the flow time required by the fluid to flow through the measuring path from the manipulation location to the detection location, which is spaced apart in the flow direction of the fluid.

According to the invention, the nuclear magnetic or electron magnetic polarisation of the fluid, i.e. the nuclear spin state or the electron spin state of the fluid, is used as the changeable state of the fluid. The macroscopic nuclear magnetic or electron magnetic polarisation is measured at the detection location as the magnetic flux density B of the magnetic field emanating from the fluid due to the nuclear magnetic or electron magnetic polarisation.

For the purposes of the present application, the nuclear magnetic polarisation of the fluid refers to the magnetic polarisation due to the collective alignment of nuclear spins of a plurality of atoms of the fluid. For the purposes of the present application, the electron magnetic polarisation of the fluid refers to the magnetic polarisation due to the collective alignment of electron spins of a plurality of atoms of the fluid.

In contrast to other flow measurements based on the nuclear magnetic or electron magnetic polarisation of a fluid, the measurement of the respective spin state of the fluid at the detection location is not carried out using a spin magnetic resonance method, but directly using magnetometry. For the purposes of the present application, magnetometry is understood to mean the measurement of a magnetic flux density of the magnetic field emanating from the fluid due to its nuclear magnetic or electron magnetic polarisation. The macroscopic nuclear magnetic or electron magnetic polarisation, which according to the invention is measured at the detection location via the magnetic flux density, is to be understood as the integral over all fields generated by the individual spins.

Figuratively speaking, the measuring principle can be imagined in such a way that a cylinder “flying” at the manipulation location is generated by changing the nuclear magnetic or electron magnetic polarisation of the fluid, which comprises a cover area corresponding to the cross-sectional area of the pipe. For example, the generation of the cover surface triggered in a controlled manner by the change in polarisation is used as a start signal at a first point in time for measuring the flow time. If, for example, this cover surface of the cylinder then arrives at the detection location, the associated change in the magnetic field emanating from the fluid serves as a stop signal at the second point in time. The difference between the start signal and the stop signal or the first point in time and the second point in time is then the flow time to be detected.

A fluid in the sense of the present application is, for example, a gas or a liquid. In particular, flowable mixtures of components with different states of aggregation, for example a suspension, are also considered. The fluid comprises at least one component comprising a nuclear spin or unpaired electrons.

In principle, it is possible to add a component to a fluid that is used exclusively to determine the flow time, as this component comprises the required nuclear magnetic or electron magnetic properties. Such a component can also be referred to as a marker.

However, the present invention advantageously makes it possible to determine the flow time for a fluid with a nuclear magnetic or electron magnetic polarisation without mixing it with an additional marker. The flow measurement according to the invention is successful with any fluid comprising a proton or a free electron.

An example of a component of a fluid with a nuclear spin is hydrogen. In an embodiment, the fluid comprises water or an oil, each of which contains hydrogen.

The nuclear magnetic or electron magnetic polarisation of different fluids relaxes on different time scales. However, this can be taken into account by adapting the measuring apparatus. For example, the distance between the manipulation location and the detection location can be selected as a function of the expected relaxation time of the nuclear magnetic or electromagnetic polarisation and as a function of the expected flow time.

A number of methods can be considered for effecting the change in the nuclear magnetic or electron magnetic polarisation of the fluid at the manipulation location at the first point in time.

In principle, it is irrelevant to the present invention how the change in nuclear magnetic or electron magnetic polarisation is effected at the first point in time, as long as it is triggered in a controlled manner at the first point in time. Therefore, changing the nuclear magnetic or electron magnetic polarisation in step B) comprises either tilting the polarisation or destroying the polarisation by radiating an electromagnetic field into the fluid or generating, destroying or changing the polarisation by applying, switching off or changing a, preferably static, magnetic field to the fluid.

The change always requires that the electromagnetic field or the, preferably static, magnetic field can be switched on and off or modulated. The aforementioned different variants for changing the nuclear magnetic or electron magnetic polarisation in step B) are described in more detail below in various embodiments thereof.

In one embodiment of the invention, a nuclear magnetic or electron magnetic polarisation of the fluid already existing when the fluid arrives at the manipulation location is changed at the first point in time. For this purpose, in an embodiment, the method comprises, prior to step B), the step of
E) generating a nuclear magnetic or electron magnetic polarisation of the fluid by flowing through a bias magnetisation path with a bias magnetic field,
wherein the method in step B) comprises the step of
irradiating an electromagnetic field into the fluid at the detection location at the first point in time.

The preferably static bias magnetisation field of the bias magnetisation path is generated either with a permanent magnet or an electromagnet, wherein the bias magnetisation field permeates the fluid flowing through and causes the polarisation of the spins of the fluid. In an embodiment of the invention, the permanent magnet of the bias magnetisation path is a Halbach array.

The atomic nuclei of the elements which have a nuclear spin also have a magnetic moment caused by the nuclear spin which points in the same direction as the nuclear spin. In the presence of a macroscopic magnetic field, the magnetic moment of an atomic nucleus aligns itself parallel to this magnetic field. The atomic nuclei now align themselves along the strong magnetic field via the bias magnetisation path and thus generate a nuclear magnetic polarisation (or magnetisation). An analogous consideration applies to the electron spins.

In an embodiment of the invention, the manipulation location is spaced apart from the bias magnetisation path by a spacer path. Preferably, a magnetic field acts on the fluid on the spacer path, which is aligned and located in such a way that the nuclear magnetic or electron magnetic polarisation is essentially maintained along the spacer path due to the bias magnetic field. This ensures that the polarisation is essentially still present at the manipulation location.

In an embodiment in which a nuclear magnetic or electron magnetic polarisation of the fluid is generated by means of a bias magnetisation path, the polarisation is changed in step B) at the manipulation location either by flipping the polarisation or by destroying the polarisation, as it was imprinted on the fluid by the bias magnetisation field in the bias magnetisation path. Both processes are caused by radiating an electromagnetic field into the fluid.

To cause a flip, a static magnetic field is applied to the fluid in addition to the electromagnetic field at the manipulation location, so that the spins undergo a precession movement. It is understood that in an embodiment of this type, the frequency of the electromagnetic field is equal to the Larmor frequency ω_{L} of the spins. The typical frequencies of the electromagnetic field radiated at the manipulation location are therefore in the range from 3 Hz to 3 THz (colloquially known as radio frequency (RF) field).

However, the electromagnetic field radiated into the fluid can be used not only to tilt the polarisation, but also to destroy the polarisation. In such a case, it is not necessarily necessary to apply a static magnetic field to the fluid in addition to radiating the electromagnetic field.

In an alternative embodiment of the invention, the polarisation existing at the manipulation location after passing through a bias magnetisation path is not changed, but rather the polarisation is generated in a controlled manner at the first point in time by means of a preferably static magnetic field. For this purpose, the method in this case comprises in step B) generating a nuclear magnetic or electron magnetic polarisation of the fluid by flowing through a magnetisation path with a switchable magnetic field, wherein the magnet is switched at the first point in time, i.e. switched on or off or its magnetic flux density acting on the fluid is changed.

It will be understood that in such an embodiment, the magnetic field is preferably generated by an electromagnet whose flux density passing through the fluid depends on the current through a coil of the electromagnet. In principle, any change in the magnetic field that has a measurable effect on the polarisation of the fluid at the detection location is suitable. However, due to the comparatively long time constants for the spin relaxation after switching off or reducing the flux density of the magnetic field, in an embodiment, switching at the first point in time is a switching on of the magnetising magnetic field.

In an embodiment of the invention, in step B) a freely selectable, preferably periodic or quasi-periodic, time characteristic is imposed on the flux density of the magnetic field emanating from the fluid detected in step C) by changing the nuclear magnetic or electron magnetic polarisation. In a sense, an amplitude modulation is imposed on the magnetic field of the fluid due to the macroscopic polarisation. The modulation methods known from the prior art for time-of-flight measurements with electromagnetic radiation at optical or radar frequencies can then be used to enable unambiguous time determination even over a larger dynamic range of the flow velocity of the fluid. It is understood that embodiments in which the polarisation generated by a bias magnetisation path is tilted or destroyed by means of an electromagnetic field are particularly suitable for the arbitrary imprinting of a time characteristic of the magnetic flux density emanating from the fluid.

In an embodiment of the invention, the magnetic flux density is measured in step C) using a magnetometer.

In principle, all types of magnetometers with sufficient sensitivity are suitable for measuring the magnetic flux density in the environment of the fluid.

In an embodiment of the invention, a magnetometer is used which comprises a high sensitivity and measures the B-field with a larger signal-to-noise ratio in order to be able to detect even small changes in the B-field. In an embodiment of the invention, the noise level of the magnetometer and the interferences are in a range of 1 pT or less.

An example of a suitable magnetometer is a super conducting quantum interference device (SQUID). However, the superconducting parts of a SQUID can only be operated at low temperatures with the necessary space-filling apparatus.

In an embodiment of the invention, the magnetometer is therefore a magnetometer that can be operated at room temperature.

A suitable magnetometer is an optically pumped magnetometer (OPM). In an optically pumped magnetometer, gaseous atoms are used as magnetic field sensors. For this purpose, the quantum mechanical spin state of the atoms is prepared (“pumped”) with laser light and the effect of the magnetic field to be measured on this state of the atoms used is read out with laser light. During preparation, the spins of the atoms in a gas cell are stimulated to rotate coherently. In the magnetic field to be measured, the spins then precess collectively with the Larmor frequency, which is proportional to the magnetic flux density. The transmission of electromagnetic radiation with a given frequency through the gas cell in turn depends on the Larmor frequency and thus the magnetic flux density to be measured. This effect of the magnetic flux density to be measured on the transmission of electromagnetic radiation through the gas cell can be measured optically.

A distinction is made between optically pumped zero-field magnetometers and optically pumped total-field magnetometers (the latter are also known as earth-field magnetometers).

The measurement in a zero-field OPM is based on a resonance that manifests itself at the zero point of the magnetic field. The light of a tuned laser penetrates the gas cell with the atoms and is detected by a photodetector behind it. If the background magnetic field is zero, the atoms in the gas cell are largely transparent. A magnetic field in a direction perpendicular to the light path causes the atoms to absorb more radiation. The photodetector detects this change in transmission, which is proportional to the light transmitted through the gas cell.

In an embodiment of such a zero-field OPM, the atoms in the gas cell have an absorption resonance without an applied magnetic field (zero field). In one embodiment, this absorption resonance in the zero field is particularly narrow (SERF; spin exchange relaxation-free); this means that the smallest changes in the magnetic flux density of the magnetic field to be measured can be detected. A small change in the magnetic field causes a larger change in the transmission of light through the gas cell. In such an embodiment, the OPM itself comprises an electromagnet for generating a compensation field. This compensation field is used to bring the magnetic field in the cell to zero in the presence of the field to be measured, wherein the output of the photodetector serves as a controlled variable. The current required to generate the compensation field is then a measure of the magnetic flux density to be measured, acting on the atoms in the gas cell and emanating from the fluid.

Total field OPMs can work with high accuracy even in the earth's magnetic field. The atoms in the gas cell have a precisely defined resonance frequency that is directly proportional to the flux density of the magnetic field to be measured. Internal coils apply a magnetic field modulated at a varying modulation frequency to the gas cell in order to resolve this resonance frequency by monitoring the light transmitted through the cell. The resonance frequency is reached when the absorption is maximised. The output signal of the magnetometer in a total field OPM is based on the value of the modulation frequency with maximum absorption, wherein this modulation frequency depends on the magnetic flux density. Total field OPMs are suitable for measurements in the earth field, i.e. without additional shielding with high accuracy.

The sensitivity of OPMs is similar to that of SQUIDs. Gaseous atoms, e.g. helium 4 (4He) and evaporated alkali metals such as potassium, rubidium or caesium, serve as the sensitive medium in an OPM. Therefore, no low, cryogenic temperatures are required for operation. OPMs can be realised with small dimensions and can therefore be completely accommodated in a sample chamber defined by a shield.

A similarly high sensitivity as with an OPM can also be provided with other magnetometers to be operated at room temperature, for example with magnetometers based on the measurement of the magnetoresistivity of a sample material, such as those commercially available from the company TDK under the brand name Nivio.

In an embodiment of the invention, the magnetometer is a zero-field magnetometer. Therefore, in an embodiment, the magnetometer is located in a magnetic shield, wherein preferably a magnetic field with a field strength of 10 μT or less, of 1 μT or less and particularly preferably of 100 nT or less is present in the shield without the fluid.

In an embodiment of the invention, the magnetic shield comprises at least two layers of an electrically conductive material with high magnetic permeability, for example a mumetal. In an embodiment of the invention, the design of the shielding is adapted to the direction of a magnetic flux density to be measured by the magnetometer and emanating from the fluid. In an embodiment of the invention, the magnetic shield comprises at least one, preferably several, conductive cylinders electrically insulated from each other.

In an embodiment of the invention, the magnetic shield for a non-modulated, i.e. static magnetic field comprises a shielding factor of 1,000 or more, preferably 3,000 or more and particularly preferably 8,000 or more. In an embodiment of the invention, the shielding factor is 10,000 or more. The shielding factor is defined as the ratio between a magnetic field at a location in the sample chamber without the magnetic shield divided by the magnetic flux density at the same location in the sample chamber with magnetic shield.

In addition, the above object is also solved by a flow meter for detecting a flow time required for a fluid to flow through a measuring path from a manipulation location to a detection location spaced from the manipulation location, according to the independent claim directed thereto in the appended claims. To solve this object, the flow meter comprises
at the manipulation location, either a coil for generating an electromagnetic field or a controllable magnetic field device for generating a variable magnetic field, wherein the coil or the magnetic field device is arranged and located in such a way that, during operation of the flow meter, a nuclear magnetic or electron magnetic polarisation of the fluid can be changed by the electromagnetic field or the magnetic field at the manipulation location,
a magnetometer at the detection location, wherein the magnetometer is arranged and located in such a way that a magnetic flux density of the magnetic field emanating from the fluid due to the nuclear magnetic or electron magnetic polarisation can be measured with the magnetometer as a function of time during operation of the flow meter,
the measuring path, wherein the measuring path is arranged and located such that, during operation of the flow meter, the fluid flows along the measuring path from the manipulation location to the detection location, and
a control and processing device,
   wherein the control and processing device is effectively connected to the coil or the magnetic field device at the manipulation location in such a way that, during operation of the flow meter, an amplitude or a frequency of the electromagnetic field generated by the coil or a magnetic flux density of the magnetic field generated by the magnetic field device can be adjustably varied in a controlled manner by the control and processing device,
   wherein the control and processing device is arranged such that during operation of the flow meter the control and processing device receives from the magnetometer a measurement signal representing the magnetic flux density of the magnetic field emanating from the fluid as a function of time, and
   wherein the control and processing device is set up in such a way that during operation of the flow meter the control and processing device determines the flow time from the measurement signal as the difference between a first point in time and a second point in time,
   wherein at the first point in time a change in the nuclear magnetic or electron magnetic polarisation of the fluid at the manipulation location is controlled by the control and processing device and wherein at the second point in time the change in the nuclear magnetic or electron magnetic polarisation at the manipulation location causes a change in the magnetic flux density of the magnetic field emanating from the fluid to be measured by the magnetometer at the detection location.

In an embodiment, the flow meter comprises a bias magnetisation path with a magnet (permanent magnet or electromagnet), wherein the bias magnetisation path is arranged and located such that, during operation of the flow meter, a static magnetic field of the magnet passes through the fluid and causes a nuclear magnetic or electron magnetic polarisation of the fluid flowing along the bias magnetisation path.

In an embodiment of the invention, the manipulation location is spaced from the bias magnetisation path by a spacer path, wherein the spacer path comprises a magnet (permanent magnet or electromagnet) and wherein the magnet is arranged and located such that, during operation of the flow meter, a stationary magnetic field acts on the fluid along the spacer path such that the nuclear magnetic or electron magnetic polarisation of the fluid is essentially maintained.

In an embodiment, the flow meter comprises a plurality of magnetometers at the detection location.

Further advantages, features and possible applications of the present invention will become apparent from the following description of embodiments thereof and the accompanying figures. In the figures, similar elements are labelled with the identical reference numbers.

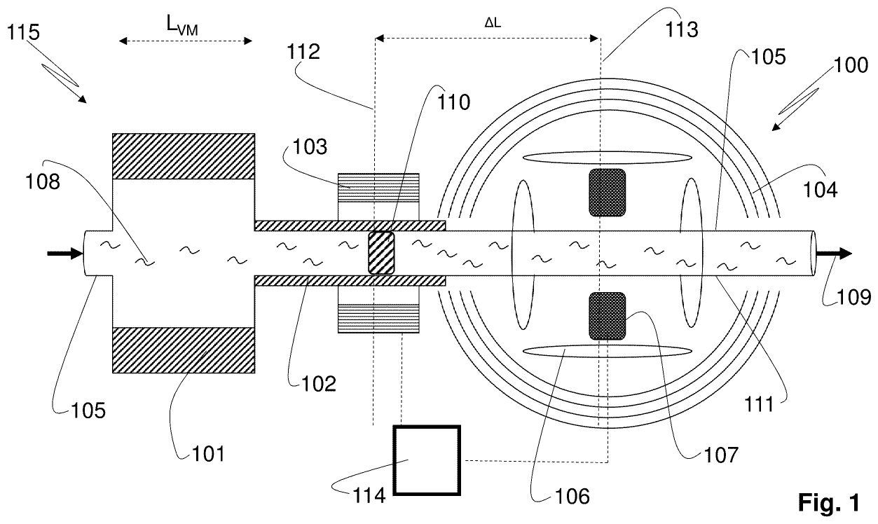

FIG. 1 is a schematic cross-sectional view of a first embodiment of the flow meter according to the invention.

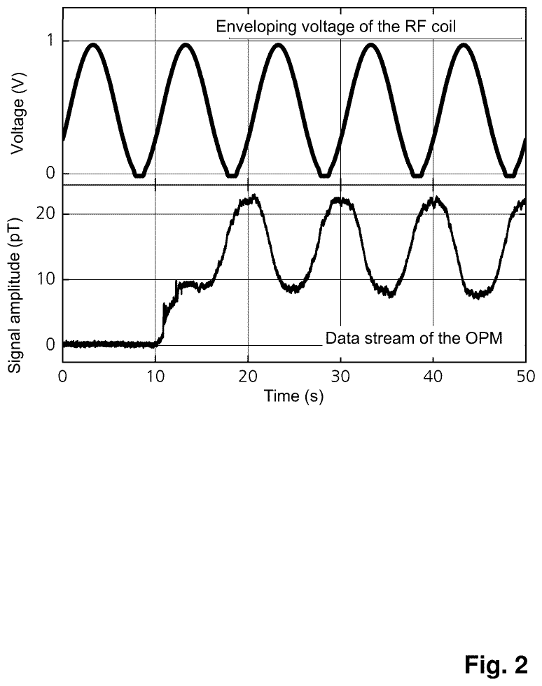

FIG. 2 shows at the top a graph with the plot of the voltage envelopes applied to the coil at the manipulation location as a function of time and at the bottom a graph with the signal amplitude detected at the detection location as a function of time.

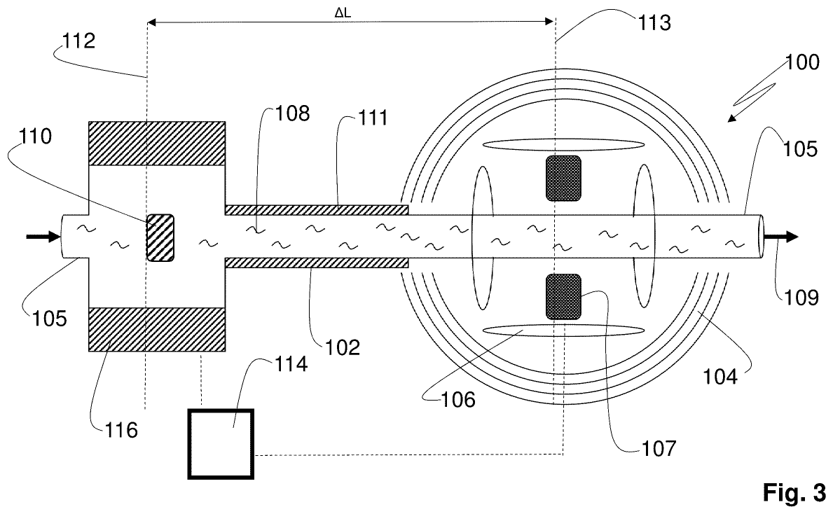

FIG. 3 is a schematic cross-sectional view of a further embodiment of the measuring device according to the invention.

FIG. 1 shows a schematic cross-sectional view of a first embodiment of a flow meter 100 according to the invention. The velocity of a fluid 108, which in the embodiment shown contains water flowing through a pipe 105 in a flow direction 109, is to be measured. For this purpose, the flow time required by the fluid 108 or a marked volume segment 110 of the fluid 108 to flow through a measuring path 111 with a path length AL between a manipulation location 112 and a detection location 113 is measured.

In the embodiment shown, the macroscopic magnetic flux density emanating from the fluid 108 in the volume segment 110 is used to mark the volume segment 110 of the fluid 108 with the water, which is associated with an aligned polarisation of the nuclear spins of hydrogen contained in the water.

At a first point in time, a computer 114 as a control and processing device within the meaning of the present application changes the nuclear spin polarisation at the manipulation location 112 and thus the magnetic flux density emanating from the volume segment 110 by outputting a corresponding control signal. The change in the nuclear magnetic polarisation of the hydrogen in the fluid 108 at the manipulation location 112 caused by the computer 114 then moves along the measuring path 111 with the fluid 108 flowing in the flow direction 109 until this volume segment 110 with the changed polarisation arrives at the detection location 113 and is detected there at a second point in time. The difference between the first point in time and the second point in time is the flow time Δt. The computer calculates the flow velocity v from the length ΔL of the measuring path 111 between the manipulation location 112 and the detection location 113 and the flow time Δt as follows:

$$v = \frac{Δ L}{Δ t}$$

The following describes how this general measuring principle is specifically implemented in the embodiment shown.

The fluid 108 with the water containing the hydrogen first flows through a bias magnetisation path 115 with a length L_{VM} in the flow meter 100, wherein in the embodiment shown the bias magnetisation path 115 comprises a permanent magnet 101. The atomic nuclei of the hydrogen, which have a nuclear spin, also generate a magnetic moment caused by the nuclear spin, which points in the same direction as the nuclear spin. The magnetic moment of the atomic nucleus is then aligned parallel to this magnetic field in the presence of the static magnetic field emanating from the permanent magnet 101. When flowing through the bias magnetisation path 115 with the length L_{VM}, the spins of the atomic nuclei are now aligned along the strong magnetic field. The structure of the magnetisation follows the following law

$$M = {M}_{0} ( 1 - exp ( - \frac{{L}_{VM}}{v {T}_{1}} ) ) ,$$

wherein v is the flow velocity of the fluid 108 and T₁ is the spin-lattice relaxation time of the hydrogen. Mₒ is the maximum magnetisation of the hydrogen (depending on the strength of the magnetic field of the permanent magnet 101).

The hydrogen thus provided with a nuclear magnetic polarisation then flows with the water through a spacer path 102 which, with the aid of a suitable arrangement of magnets, in the embodiment shown an electromagnet in the form of a racetrack coil, substantially maintains the polarisation generated in the bias magnetisation path 115.

Without the measures taken at the manipulation location 112, the fluid 108 would reach the detection location 113 with a substantially constant nuclear magnetic polarisation of the hydrogen and thus a substantially constant magnetic flux density emanating from the fluid 108 over time. If the magnetic flux density of the magnetic field emanating from the nuclear magnetic polarisation of the hydrogen is detected there, it is essentially constant over time.

Furthermore, a radio frequency coil 103 for radiating an electromagnetic field into the fluid 108 is located at the manipulation location 112. In addition, a permanent magnet with a correspondingly aligned magnetic field is provided at the manipulation location (not shown in FIG. 1). The magnetisation undergoes a precession movement in such a static magnetic field. The frequency of the precession is called the Larmor frequency (ω_{L} and is proportional to the magnitude of the magnetic flux density of the permanent magnet (ω_{L}=γB, wherein γ is the gyromagnetic ratio of the atomic nucleus). By coupling the precessing magnetisation to an irradiated electromagnetic RF field with the Larmor frequency ω_{L}, which is generated with the coil 103, the orientation of the nuclear magnetic magnetisation flips. This process, also known as “spin flip”, can also be modulated by modulating the RF field generated by the coil 103 and radiated into the fluid 108. If the RF field generated by the coil 103 has a maximum amplitude at a first point in time T1, the fluid 108 will flow from the manipulation location 112 to the detection location 113 with a maximum proportion of the flipped magnetisation from this first point in time. On “arrival” of the fluid 108 with the flipped polarisation, this can be measured by a change in the magnetic flux density emanating from the fluid at the detection location 113.

By switching the coil 103 on and off or by modulating the amplitude of the RF field generated by the coil and radiated into the fluid 108, a signal or signal sequences can be imprinted on the nuclear magnetic polarisation of the hydrogen and thus on the flux density of the magnetic field emitted by the fluid 108.

The embodiments of FIGS. 1 and 3 each utilise an optically pumped zero-field magnetometer (OPM) to detect the magnetic flux density at the detection location 113. Zero-field sensors can only measure extremely low magnetic flux densities, wherein all ambient fields must be shielded.

Therefore, the magnetometer 107 is located in a magnetic shield 104, but outside the conduit 105. In the embodiments shown, the shield 104 consists of four concentric hollow cylinders, electrically insulated from each other, made of a mumetal sheet with high electrical conductivity and high magnetic permeability. A magnetic ambient field can be applied to the shield 104 via suitably located coils 106 in order to operate the magnetometer at its ideal operating point.

FIG. 2 shows a measured example of a series of measurements with the flow meter 100 of FIG. 1. The periodic amplitude modulation of the RF coil 103 is shown in the upper graph of FIG. 2. The graph shows the enveloping voltage used to drive the amplitude modulation of the RF signal plotted in volts versus time in seconds.

The lower graph in FIG. 2, on the other hand, shows the signal amplitude in pT plotted against the time in seconds at the magnetometer 107. The time axes of the upper graph and the lower graph are identical. The time offset between each maximum voltage of the signal amplitude of the irradiated RF field at the manipulation location 112 and the corresponding maximum signal amplitude triggered by the spin flip at the detection location 113 is clearly recognisable. This offset is equal to the flow time At required by the volume segment 110 of the water 108 from the manipulation location 112 to the detection location 113.

FIG. 3 shows an alternative embodiment of the flow meter 100, wherein this variant does without the coil 103 for the RF field. Instead, the bias magnetisation path 115 is replaced by an electromagnet 116 that can be switched on and off by the computer 114. In this embodiment, the measuring path 111 therefore extends from the manipulation location 112 in the area of the electromagnet 116 to the detection location 113. As long as the electromagnet 116 is switched off, the orientation of the nuclear magnetic spins of the individual molecules of the water 108 is statistically disordered and there is no macroscopic polarisation that can be measured as magnetic flux density.

If the electromagnet 116 is switched on at the first point in time, a nuclear magnetic magnetisation occurs, just as it was previously permanently generated in the bias magnetisation path 115. If the switching on of the electromagnet 116 is set as the start signal, the flow time required by a polarised volume segment 110 from the manipulation location to the detection location 113 can again be measured, as previously described for the embodiment of FIG. 1.

For the purposes of the original disclosure, it is pointed out that all features as they are apparent to a person skilled in the art from the present description, the drawings and the claims, even if they have been described specifically only in connection with certain further features, can be combined both individually and in any combination with other features or groups of features disclosed herein, unless this has been expressly excluded or technical circumstances make such combinations impossible or meaningless. A comprehensive, explicit description of all conceivable combinations of features is omitted here only for the sake of brevity and readability of the description.

Whilst the invention has been illustrated and described in detail in the drawings and the preceding description, this illustration and description is given by way of example only and is not intended to limit the scope of protection as defined by the claims. The invention is not limited to the disclosed embodiments.

Variations of the disclosed embodiments will be obvious to those skilled in the art from the drawings, the description and the appended claims. In the claims, the word “comprising” does not exclude other elements or steps, and the indefinite article “a” does not exclude a plurality. The mere fact that certain features are claimed in different claims does not exclude their combination. Reference numbers in the claims are not intended to limit the scope of protection.

### REFERENCE NUMBERS

100 Flow meter
101 Permanent magnet
102 Spacer path
103 Coil
104 Shield
105 Pipe
106 Coils
107 Magnetometer
108 Fluid
109 Flow direction
110 Volume segment
111 Measuring path
112 Manipulation location
113 Detection location
114 Computer
115 Pre-magnetization path
116 Switchable electromagnet

1. A method for detecting a flow time required by a fluid to flow through a measuring path from a manipulation location to a detection location spaced from the manipulation location in a flow direction of the fluid, the method comprising:
A) providing a flow of the fluid,
B) at a first point in time, changing a nuclear magnetic or electron magnetic polarisation of the fluid at the manipulation location,
C) measuring a magnetic flux density of a magnetic field emanating from the fluid due to the nuclear magnetic or electron magnetic polarisation as a function of time at the detection location, and
D) determining the flow time as a difference between the first point in time and a second point in time, wherein at the second point in time the change in the nuclear magnetic or electron magnetic polarisation at the manipulation location from step B) causes a change in the flux density of the magnetic field emanating from the fluid at the detection location.

2. The method according to claim 1, wherein changing the nuclear magnetic or electron magnetic polarisation in step B) comprises either tilting the polarisation or destroying the polarisation by radiating an electromagnetic field into the fluid or generating the polarisation by applying a magnetic field to the fluid, destroying the polarisation by switching off a magnetic field or changing the polarisation by changing a magnetic field.

3. The method according to claim 1, wherein the method comprises the step before step B):
E) generating a nuclear magnetic or an electron magnetic polarisation of the fluid by flowing through a bias magnetisation path comprising a bias magnetic field, and
wherein the method in step B) comprises the step of
irradiating an electromagnetic field into the fluid at the detection location at the first point in time.

4. The method according to claim 3, wherein the manipulation location is spaced apart from the bias magnetisation path by a spacer path, wherein a magnetic field preferably acts on the fluid on the spacer path so that the nuclear magnetic or electron magnetic polarisation is substantially maintained.

5. The method according to claim 1, wherein the method in step B) comprises:
generating a nuclear magnetic or an electron magnetic polarisation of the fluid by flowing through a magnetisation path comprising a switchable magnetic field, wherein the magnetic field is switched at the first point in time.

6. The method according to claim 1, wherein in step B) a freely selectable, preferably periodic or quasi-periodic, time characteristic is imposed on the flux density of the magnetic field emanating from the fluid detected in step C) by changing the nuclear magnetic or electron-magnetic polarisation.

7. The method according to claim 1, wherein in step C) the measurement of the magnetic flux density is carried out with a magnetometer.

8. The method according to claim 7, wherein the magnetometer is located in a magnetic shield, wherein preferably in the magnetic shield without the fluid there is a magnetic field having a field strength of 100 nT or less.

9. A flow meter for detecting a flow time required by a fluid to flow through a measuring path from a manipulation location to a detection location spaced from the manipulation location, the flow meter comprising a coil for generating an electromagnetic field or a controllable magnetic field device for generating a magnetic field at the manipulation location,
wherein the coil or the magnetic field device is located and arranged in such a way that during operation of the flowmeter a nuclear magnetic polarisation or an electron magnetic polarisation of the fluid can be changed by the electromagnetic field or the magnetic field at the manipulation location,
a magnetometer at the detection location,
wherein the magnetometer is arranged and located in such a way that a magnetic flux density of the magnetic field emanating from the fluid due to the nuclear magnetic or electron magnetic polarisation can be measured as a function of time with the magnetometer during operation of the flowmeter,
the measuring path,
wherein the measuring path is arranged and located in such a way that during operation of the flowmeter the fluid flows along the measuring path from the manipulation location to the detection location, and
a control and processing device,
wherein the control and processing device is effectively connected to the coil or the magnetic field device at the manipulation location in such a way that, during operation of the flow meter, an amplitude or a frequency of the electromagnetic field generated by the coil or a magnetic flux density of the magnetic field generated by the magnetic field device can be varied in a controlled and adjustable manner by the control and processing device,
wherein the control and processing device is operatively connected to the magnetometer such that during operation of the flow meter the control and processing device receives from the magnetometer a measurement signal representing the magnetic flux density of the magnetic field emanating from the fluid as a function of time, and
wherein the control and processing device is set up such that during operation of the flow meter the control and processing device determines the flow time from the measurement signal as the difference between a first point in time and a second point in time,
wherein a change in the nuclear magnetic or electron magnetic polarisation of the fluid at the manipulation location takes place at the first point in time, and
wherein at the second point in time the change in the nuclear magnetic or electromagnetic polarisation at the manipulation location causes a change in the magnetic flux density of the magnetic field emanating from the fluid to be measured by the magnetometer at the detection location.

10. The flow meter according to claim 9, wherein the flow meter comprises a bias magnetisation path comprising a magnet,
wherein the bias magnetisation path is arranged and located such that, during operation of the flowmeter, the magnet causes a nuclear magnetic or an electromagnetic polarisation of the fluid flowing along the bias magnetisation path.

11. The flow meter according to claim 10, wherein the manipulation location is spaced from the bias magnetisation path by a spacer path, wherein the spacer path comprises a magnet and wherein the magnet is arranged and located such that, during operation of the flow meter, a stationary magnetic field acts on the fluid along the spacer path such that the nuclear magnetic or electron magnetic polarisation of the fluid is substantially maintained.

12. The flow meter according to claim 9, wherein the magnetometer is located in a magnetic shield.

13. The flow meter (100) according to claim 9, wherein the magnetometer is an optically pumped magnetometer.

14. The flow meter (100) according to claim 9, wherein the flow meter comprises a plurality of magnetometers at the detection location having different orientations from each other.
